(19) United States
(12) Patent Application Publication
(10) Pub. No.: US 2010/0312787 A1
(43) Pub. Date: Dec. 9, 2010

(54) Control of Search Scope

(75) Inventors: Arto Kristian Mattila, Lempaala (FI); Likka Meriala, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/513,391

(22) PCT Filed: Nov. 4, 2006
(86) PCT No.: PCT/IB2006/003988

§ 371 Date: Jul. 6, 2010

(51) Int. Cl. G06F 17/30

(52) U.S. Cl. 707/769; 707/E17.014

(57) ABSTRACT

Dynamic user control of a scope of search while the search is on-going and without terminating the search. A method comprising: enabling user definition of a search object; starting a first search with a first scope for the search object; and while the first search is in progress, dynamically changing the search scope from the first search scope to a second search scope without terminating the first search. A graphical user interface comprising: a first screen portion for enabling a search; and a further screen portion for enabling dynamic user definition of a scope of the on-going search without terminating the search.

### FIELD OF THE INVENTION

Embodiments of the present invention relate to control of search scope. In particular, they relate to a methods, devices and computer program products for controlling search scope.

### DEFINITIONS

The term ‘database’ means any searchable collection of data.

The term ‘terminating’ means stopping as if completed.

The term ‘pausing’ means temporarily stopping for future completion.

### BACKGROUND TO THE INVENTION

It is now common practice to use an electronic device to search a database. For example, a personal computer may be used to access the Internet and use a search engine such as GOOGLE.

It is also possible for a user of a device to store personal data on the device and/or at a remote location. If a user wishes to search all of their personal data they may need to search multiple storage locations. A user may also only wish to search for particular content.

Consequently a data search may cover many content classes and/or many different storage locations or be otherwise limited or directed in scope.

It may be difficult and time consuming to specify search parameters that define the content classes and/or locations to be searched. It is therefore a difficult and time consuming matter to control the scope of a search.

It would be desirable to provide for improved control of the scope of a search.

### BRIEF DESCRIPTION OF THE INVENTION

According to one embodiment of the invention there is provided a method comprising: enabling user definition of a search object; starting a first search with a first scope for the search object; and while the first search is in progress, dynamically changing the search scope from the first search scope to a second search scope without terminating the first search.

According to another embodiment of the invention there is provided a method comprising: defining a search object; starting a first search with a first scope for the search object, wherein the search includes a plurality of distinct sub-searches; starting at least one sub-search; while a sub-search is in progress, detecting user selection of sub-search(es); adapting an on-going sub-search if not a selected sub-search; and performing the user selected sub-search(es).

According to another embodiment of the invention there is provided a method comprising: inputting a search object; starting a first search with a first scope for the search object, using a set of alternative search parameters, each one of the alternative search parameters defining a sub-search; starting at least one sub-search; while a sub-search is in progress, detecting user selection of a sub-set of the set of alternative search parameters from the set of alternative search parameters during a sub-search; de-prioritizing an on-going sub-search if the search parameter defining that sub-search is not in the sub-set of alternative search parameters; and performing the sub-search(es) that is/are defined by the sub-set of the set of alternative search parameters.

According to another embodiment of the invention there is provided a device comprising: a user input for defining a search object and for starting a search with a scope for the input search object; and
a processor, for enabling dynamic user definition of the search scope using the user input without terminating the first search while the first search is in progress.

According to another embodiment of the invention there is provided a computer program comprising computer program instructions that enable: user definition of a search object; a search with a scope for the search object;

and dynamic user definition of the search scope without terminating the search while the search is in progress.

According to another embodiment of the invention there is provided a graphical user interface comprising: a first screen portion for enabling a search; and a further screen portion for enabling dynamic user definition of a scope of the on-going search without terminating the search.

### BRIEF DESCRIPTION OF THE DRAWINGS

For a better understanding of the present invention reference will now be made by way of example only to the accompanying drawings in which:

FIG. 1 schematically illustrates an electronic device;

FIG. 2A and 2B schematically illustrate screens presented in a graphical user interface;

FIG. 3 illustrates a process for performing a first embodiment in which a user, while a search is in progress, dynamically controls a scope of the search without terminating the search; and

FIG. 4 illustrates a process for performing a second embodiment in which a user, while a search is in progress, dynamically controls a scope of the search without terminating the search.

### DETAILED DESCRIPTION OF EMBODIMENTS OF THE INVENTION

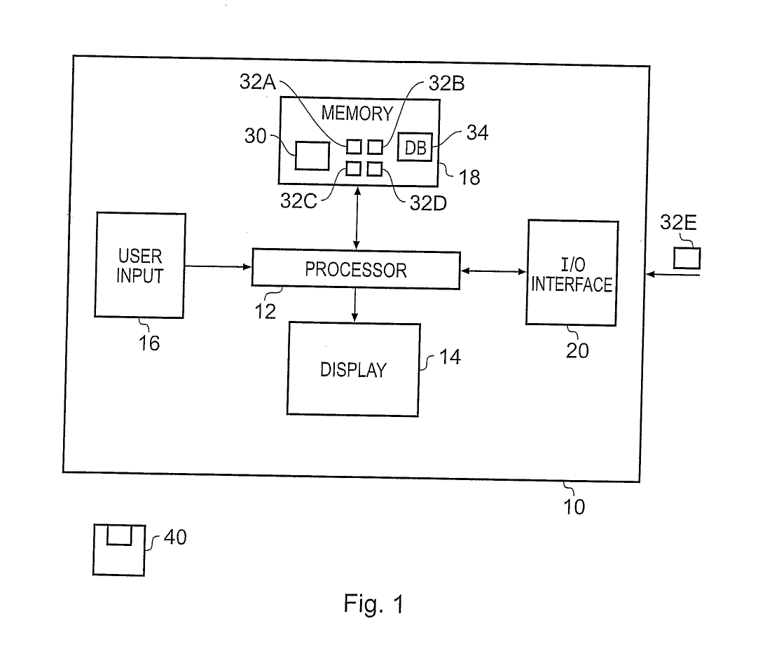

FIG. 1 schematically illustrates an electronic device 10. The electronic device is, in this example, a device that is capable of requesting a database search and capable of displaying the results of the database search. The database may be located in the device or it may located remote from the device. The term ‘database’ means any searchable collection of data.

The electronic device 10 may be a portable device that is sized so that it may be carried in the hand or a pocket. Such devices include mobile cellular telephones, personal digital assistants, personal entertainment consoles, digital music players etc. The electronic device 10 may alternatively be a larger device such as, for example, a personal computer workstation or an on-board computer of a vehicle.

The illustrated electronic device 10, in this example, comprises a processor 12, a user output device 14 such as a display, a user input device 16, and a memory 18. In this example, the device also comprises an input/output interface 20 but this may be absent from other implementations.

The processor 12 is connected to read from and write to the memory 18, to receive command signals from the user input device 16 and to provide command signals to the user output device 14.

The memory 18 although illustrated as a single entity may in fact be comprised of multiple different memory devices such as hard disk drives, flash memory devices, RAM memory, removal memory devices such as secure digital cards etc.

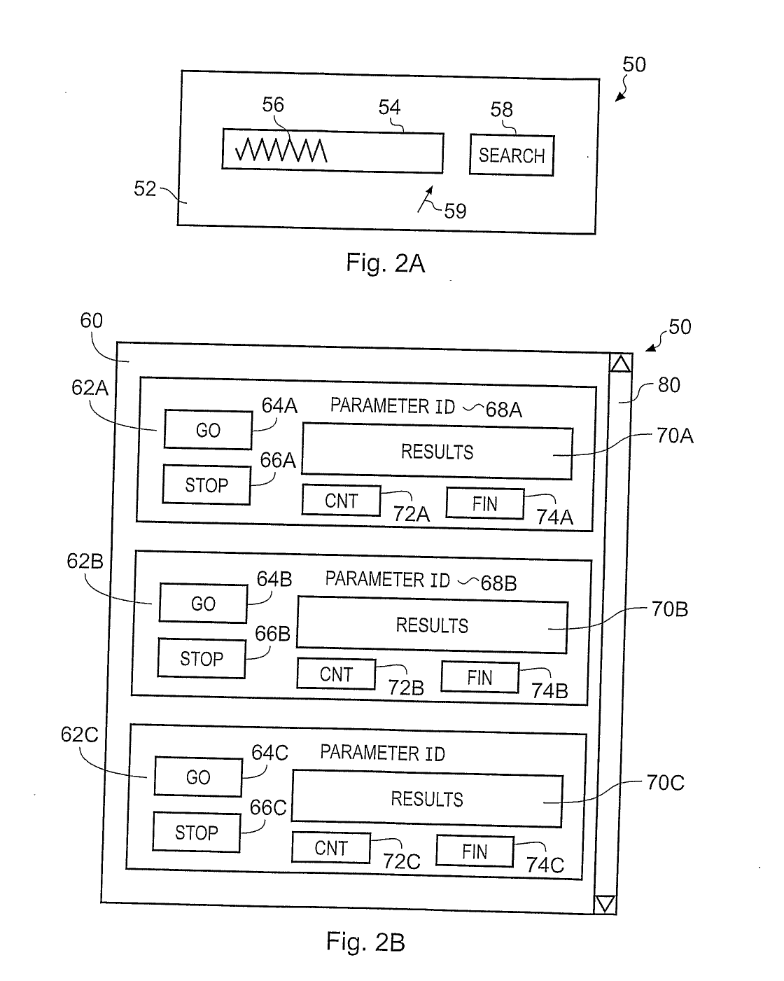

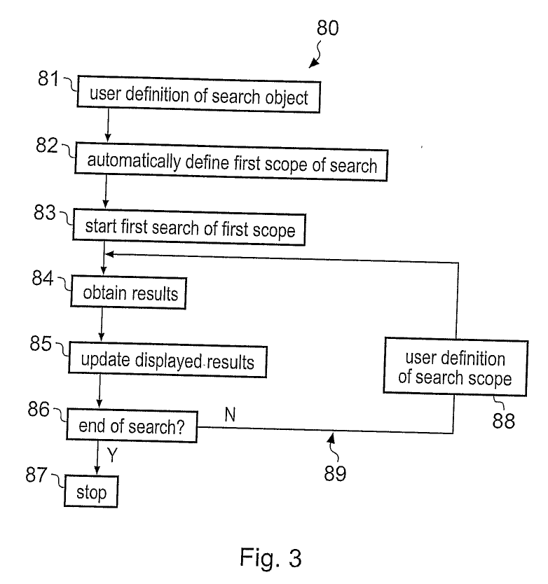

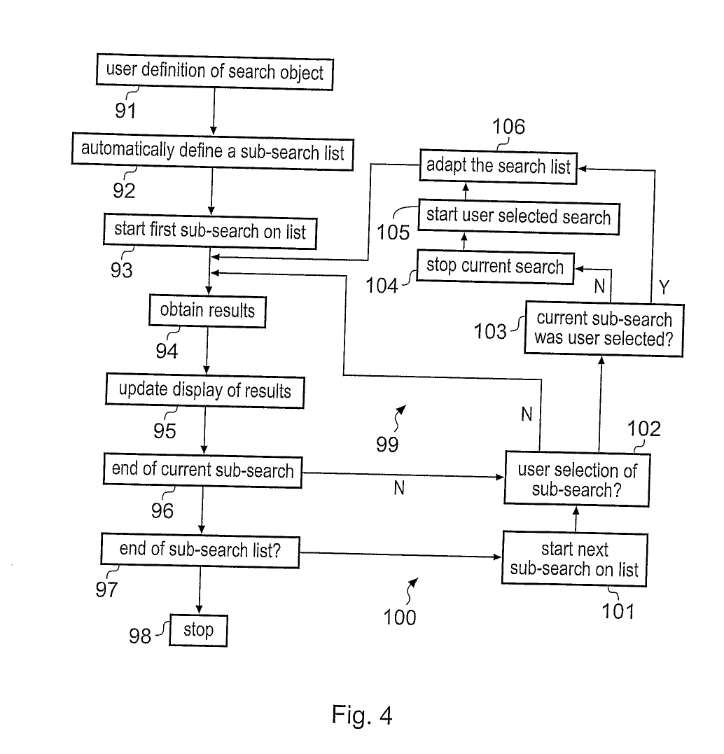

The memory 18 stores a computer program 30 comprising computer program instructions that control the operation of the device 10. When the computer program 30 is loaded into the processor 12 it provides the logic and routines for performing a method illustrated in FIG. 3 or 4 and for generating the graphical user interface illustrated in FIGS. 2A and 2B.

The memory also stores ‘plug-in’ computer program modules 32A, 32B, 32C, 32D. Plug-in modules 32 are designed to interface with the computer program 30. A plug-in module 32 enables one or more specific sub-searches (described later). The functionality of the computer program 30 may be changed by changing the stored plug-in modules 32. For example, a search for a new type of content class may be enabled by downloading a new plug-in module 32E via the I/O interface 20 and storing it in the memory 18.

The computer program 20 and/or a plug-in module may arrive at the electronic device 10 via an electromagnetic carrier signal or be copied from a physical entity 40 such as a computer program product, a memory device or a record medium such as a CD-ROM or DVD.

In this example, the memory 18 also stores a searchable database 34. This database may be searched using the computer program 30. In other implementations, the databases to be searched may be located in the device 10 and also at one or more remote locations that are remotely accessed by the device via the I/O interface 20, may be located wholly on the device 10 or may be located wholly at one or more remote locations that are remotely accessed by the device via the I/O interface 20.

The user input device 16 is any suitable mechanism that enables a user to provide an input to a device 10. The input may, for example, be via speech, touch, movement, etc One form of user input device 16 is a cursor control device, this allows a user to move a cursor with a graphical user interface (GUI) and to select items within the GUI. Another form of user input device is a touch sensitive display screen.

The user output device 14 may be any suitable mechanism for conveying information to a user. The user output device 14 may, for example, be or comprise a display that conveys visual information to a user. Typically it may be a liquid crystal display but of course other displays are possible. The user input device may, for example, be or comprise an audio output device such as a jack or loudspeaker.

Although a single processor 12 has been illustrated, it will be understood that the functionality of the processor may be performed by more than one device.

Although the device is illustrated as comprising a programmable processor 12 and memory combination, in other implementations dedicated circuitry such as an application specific integrated circuit may be used.

The input/output interface 20 may be any suitable communication interface. It may be, for example, a galvanic interface (e.g. USB, Ethernet, Firewire etc) or a wireless interface (Infrared, Bluetooth, WLAN, cellular radio etc).

FIG. 2A and 2B schematically illustrate screens presented in a graphical user interface 50 during a search application controlled by the computer program 30. It will of course be appreciated that these screens are schematic representations of one possible implementation and that many alternative graphical user interfaces 50 may be used. In particular, although in this implementation the initial search GUI and the search GUI are illustrated as separate screens 52 and 60 in other implementations the initial search GUI and the search GUI may be portions of the same screen as opposed to portions of different screens.

FIG. 2A illustrates an initial search screen 52. It comprises an input field 54 and a search button 58.

The input field 54 is where a user defines a search object 56. The search object may be, for example, a text string (e.g. a word or words with/without Boolean operators), an audio clip, an image, a current location of the user etc. In some implementations the input field 54 may be filled automatically by another application.

When the search object has been defined, the search is started, in this example, by user input i.e. selecting the ‘search’ button 58 using the cursor 59. In other implementations, different mechanisms for starting the search may be used, for example, the search may be started automatically if the input field is filled automatically by another application.

FIG. 2B illustrates a search screen 60 that is immediately displayed after the user selects the search button 58. This screen is displayed while the search is on-going and when the search has completed. It enables a user to control the search scope of an ongoing search on the fly while the search is on-going.

The search screen 50 comprises a plurality of user selectable sub-searches.

The user is able to dynamically vary the scope of the search by dynamically varying the prioritization of sub-searches. The priority of a sub-search may be used to determine whether or not a particular sub-search is performed and, if it is performed, when it is performed.

The search may comprise a ‘parallel component’ in which multiple sub-searches are carried out concurrently. The scope of the parallel component may be
dynamically varied by varying which sub-searches define the parallel component e.g. by user selection of which of the plurality of sub-searches are carried out concurrently. Greater processing resources may be allocated to sub-searches of higher priority and the priority of some or all of the sub-searches defining the parallel component may be user specified.

The search may comprise a ‘sequential component’ in which multiple sub-searches are carried out sequentially. The scope of the sequential component may be dynamically varied by varying the sub-searches making up the sequential component e.g. by user selection of which of the plurality of sub-searches are carried out sequentially. The priority of the sub-searches defining the sequential component may also be user specified with the sequential order of the sub-searches being in priority order.

It should be appreciated that a search may comprise a combination of parallel component(s) and sequential component(s).

The sub-searches may be performed in an order specified by the order in which the sub-searches are selected.

An on-going sub-search may be permanently or temporarily halted by de-selecting that sub-search. De-selection may be explicit in the sense that a user action is performed in relation to the de-selected sub-search or implicit in that selection of another sub-search de-selects the current sub-search.

A particular non-limiting example of a search screen 50 is illustrated in FIG. 2B. The search screen 50 comprises a plurality of sub-search compartments 62A, 62B, 62C. These may be only some of the displayable sub-search compartments 62, further different sub-search compartments being viewable by scrolling the display using the scrollbar 80.

A sub-search compartment is associated with a particular sub-search. The dynamic control of the search is provided via user input that is used to select and possibly to de-select sub-searches. In the example illustrated buttons 64, 66 in the sub-search compartments are used to respectively select and de-select the associated sub-search. It should be appreciated that other mechanisms for selection and de-selection may alternatively or additionally be used.

The results of the search are provided in real time, as the search progresses, e.g. via the information fields 70, 72, 74 of the sub-search compartments. The current results of a sub-search are presented in the information fields 70, 72, 74 of the sub-search compartment associated with that sub-search.

The sub-search compartments 62 comprise a ‘go’ button 64 and a ‘stop’ button 66. The ‘go’ button 64 is selected by a user while the search is on-going to increase the priority of the sub-search associated with the sub-search compartment within which the selected ‘go’ button 64 is located. The ‘stop’ button 64 is selected by a user while the search is on-going to decrease the priority of the sub-search associated with the sub-search compartment within which the selected ‘go’ button 64 is located.

The search starts with a certain order of sub-searches or with certain sub-searches. The user is able to dynamically vary the scope of the search by dynamically varying the order of the sub-searches and/or by varying the sub-searches making up the search.

For example, the sub-searches may be performed in an order specified by the order in which the associated compartment's ‘go’ buttons are selected.

For example, an on-going sub-search may be permanently or temporarily halted by selecting the ‘stop’ button in the compartment associated with that sub-search.

The compartments 62 also comprise a header 68 that identifies the sub-search associated with the compartment. A sub-search may be defined by a specific search parameter and the header 68 may identify the search parameter.

The information fields 70, 72 and 74 provide the results on the sub-search associated with the compartment 62. The results themselves are displayed in field 70. The results are the current real-time search results and are updated as the sub-search progresses. If the sub-search is stopped, the content of the field 70 remains unchanged. The results may be scrolled within the field 70.

The information field 72, which is optional, displays the number of current hits for the sub-search.

The information field 74, which is optional, indicates whether or not the sub-search has finished.

FIG. 3 illustrates a process 80 for performing a first embodiment in which a user, while a search is in progress, dynamically changes a scope of the search from a first search scope to a second search scope without terminating the search.

At block 81, a user is able to define a search object of a search and request the search.

Next at block 82, the device 10 automatically defines a first scope for the search.

Next at block 83, the device 10 automatically starts to perform the search with the defined first scope.

Next at block 84, the initially returned search results are received or a timeout occurs and the clock is re-set. The threshold for the timeout may be, for example, of the order 0.5 to 1 second.

Next at block 85, the cumulatively received search results are updated to include the search results received in block 84.

Next at block 86, if the search has not been completed the procedure loops 89 back to obtain and display results for the search but if the search has been completed the procedure moves to block 87 where it terminates.

The loop 89 includes a block 88. This block 88 determines whether a user has changed the definition of the search scope from the first scope automatically determined at block 82 to a user defined second scope.

The first scope may be defined by a plurality of search parameters. The second scope may be defined by user determined search parameters. The search parameters are independent and a search parameter defines a sub-search.

In one example the search parameters may be used to indicate different content classes, where the search only searches for results in the content classes identified by the search parameters that define the current scope of search. Examples of different content classes include documents, messages, calendar items, contacts, pictures, multimedia clips, notes.

In another example the search parameters may be used to indicate different storage locations, where the search only searches for results at the storage locations identified by the search parameters that define the current scope of search. Examples of different storage locations include local (i.e. in the device 10) and remote. The remote locations may be further differentiated according to the average access speed.

In another example the search parameters may be used to indicate different content classes and/or indicate different storage locations.

The blocks may be components of the computer program or steps in a method.

FIG. 4 illustrates a process 90 for performing a second embodiment in which a user, while a search is in progress, dynamically controls a scope of the search by changing the scope from a first search scope to a second search scope without terminating the search. The scope may be limited or changed for example.

At block 91, a user is able to define a search object of a search and request the search.

Next at block 92, the device 10 automatically defines a first scope for the search. The device 10 automatically creates a list of sub-searches.

Next at block 93, the device 10 automatically starts to perform the search with the defined first scope by performing the first sub-search in the list of sub-searches.

Next at block 94, the initially returned search results for the current sub-search are received or a timeout occurs and the clock is re-set. The threshold for the timeout may be, for example, of the order 0.5 to 1 second.

Next at block 95, the cumulatively received search results are updated, in the information field 70 of the compartment 62 associated with the current sub-search to include the search results received in block 94. In addition, the information field 72 is updated to reflect the current number of hits for the current sub-search.

Next at block 96, if the current sub-search has not been completed the procedure loops 99 back to obtain and display results for the search but if the sub-search has been completed the procedure moves to block 97 where information field 74 is updated to indicate that the sub-search has finished.

At block 97, if the search has not been completed the procedure loops 100 back to obtain and display initial results for the next sub-search on the list but if the search has been completed the procedure moves to block 98 where it terminates.

The loop 99 includes a block 102. This block determines whether a user has changed the definition of the search scope from the first scope automatically determined at block 82 to a user defined second scope. If they have not, the procedure returns to block 94 to continue the current sub-search. If they have, the procedure moves to block 103.

At block 103 it is determined whether the current sub-search was a user selected sub-search. That is it was selected at block 102 previously in the procedure.

If the current sub-search was not user selected then it is a default sub-search defined at block 93. The procedure moves to block 104 where the current sub-search is stopped and then moves to block 105 where the sub-search selected at block 102 is started. Then at block 106 the search list is adapted to place the user selected sub-search at the top.

If the current sub-search was user selected then the procedure moves from block 103 to block 106 where the search list is adapted.

In one example, the search list comprises only user selected sub-searches arranged in the order in which they were user selected, so that first user selected sub-search is performed first. In this example, user selection of a sub-search terminates an on-going default sub-search and prevents other sub-searches from the default search list being performed.

In another example, the search list comprises user selected sub-searches at its head arranged in the order in which they were user selected, so that first user selected sub-search is performed first and then comprises the original list of sub-searches defined at block 92 (with the removal of any user selected sub-searches to avoid duplication). In this example, user selection of a sub-search suspends an on-going default sub-search (until the user selected sub-searches have been completed) and delays other sub-searches from the default search list that are not also user selected.

After block 106, the procedure returns to block 94.

The loop 100 includes a block 101 which leads to the block 102. At block 101 the next sub-search in the current search list is started.

The first scope may be defined by a plurality of default search parameters. The second scope may be defined by user determined search parameters. The search parameters are independent and a search parameter defines a sub-search.

The blocks may be components of the computer program or steps in a method.

The search parameters may, for example, be used to indicate different content classes and/or indicate different storage locations.

It will be appreciated that FIG. 4 illustrates an embodiment in which sub-searches are performed sequentially. In other embodiments the sub-searches of the search list may be performed in parallel.

Although embodiments of the present invention have been described in the preceding paragraphs with reference to various examples, it should be appreciated that modifications to the examples given can be made without departing from the scope of the invention as claimed. For example, additional embodiments of the invention may be created by pausing a search when it is described above as terminated and also by terminating a search when it is described as paused.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
defining a search object;
starting a first search with a first scope for the search object; and
while the first search is in progress, dynamically changing the search scope from the first search scope to a second search scope without terminating the first search.

2-35. (canceled)

36. A method according to claim 1 wherein adapting an on-going search involves decreasing the resources allocated to the on-going search.

37. A method according to claim 1 wherein adapting an on-going search involves pausing the on-going search.

38. A method according to claim 1 wherein sub-searches are performed in parallel.

39. A method according to claim 1 wherein sub-searches are performed in sequence.

40. A method as claimed in claim 1, wherein user selected sub-searches are performed in a sequential order defined by the user.

41. A method as claimed in claim 1, wherein the sub-searches are performed in an order that is dependent upon an order of user selection.

42. A method according to claim 1, further comprising restarting the stopped sub-search after completing the user selected sub-searches.

43. A method according to claim 1, further comprising resuming the stopped sub-search after completing the user selected sub-searches.

44. A method according to claim 1 wherein a sub-search is performed using a plug-in software component.

45. An apparatus comprising:
a user input configured to define a search object and for starting a search with a scope for the input search object; and
a processor configured to:
start a first search with a first scope for the search object, wherein the search includes a plurality of distinct sub-searches;
start at least one sub-search;
detect user selection of sub-searches during a sub-search is in progress;
adapt an on-going sub-search if not a selected sub-search; and
perform the user selected sub-searches.

46. An apparatus according to claim 45 wherein the processor is further configured to adapt an on-going search involves decreasing the resources allocated to the on-going search.

47. An apparatus according to claim 45 wherein the processor is further configured to adapt an on-going search involves pausing the on-going search.

48. An apparatus according to claim 45 wherein the processor is further configured to perform sub-searches in parallel.

49. An apparatus to claim 45 wherein the processor is further configured to perform sub-searches in sequence.

50. An apparatus as claimed in claim 45, wherein the processor is further configured to perform user selected sub-searches in a sequential order defined by the user.

51. An apparatus as claimed in claim 45, wherein the processor is further configured to perform sub-searches in an order that is dependent upon an order of user selection.

52. An apparatus according to claim 45, wherein the processor is further configured to restart the stopped sub-search after completing the user selected sub-searches.

53. An apparatus according to claim 45, wherein the processor is further configured to resume the stopped sub-search after completing the user selected sub-searches.

54. An apparatus according to claim 45 wherein the processor is further configured to perform a sub-search using a plug-in software component.
